(19) United States
(12) Patent Application Publication
(10) Pub. No.: US 2006/0174611 A1
(43) Pub. Date: Aug. 10, 2006

(54) Exhaust gas cooler

(76) Inventors: Roland L. Dilley, Lomita, CA (US); Richard P. Beldam, Torrance, CA (US); Keith D. Agee, Torrance, CA (US); Wagner M. Magalhaes, Torrance, CA (US)

Correspondence Address: HONEYWELL TURBO TECHNOLOGIES, 23326 HAWTHORNE BOULEVARD, SUITE #200, TORRANCE, CA, 90505, US

(21) Appl. No.: 11/052,651

(22) Filed: Feb. 7, 2005

(51) Int. Cl. F01N 3/02; F02M 25/07

(52) U.S. Cl. 60/320; 123/568.12

(57) ABSTRACT

An exhaust gas cooler comprising an inlet chamber shaped to restrict exhaust gas flow to certain exhaust gas passages provided therein is disclosed. The inlet chamber may comprise a flow deflector which deflects a proportion of exhaust gas into, for example, the upper exhaust gas cooling passages thus restricting flow to lower exhaust gas cooling passages. In one embodiment the flow deflector is rotatably mounted and can also function as a bypass valve. Alternatively apertures provided within plates which can collectively define the inlet chamber may be of a differing size to restrict exhaust gas flow to certain exhaust gas cooling passages. A more balanced flow through the various exhaust gas cooling passages results increasing heat-exchange efficiency of the exhaust gas cooler.

### BACKGROUND OF THE INVENTION

1. Field of the Invention

The present invention relates to an exhaust gas cooler, in particular an exhaust gas recirculation (EGR) cooler.

2. Description of the Related Art

Emissions regulations are requiring reduced emissions from vehicles, particularly the Euro 5, Bin 5 and US 07 regulations. To reduce the generation of nitrous oxides, it is known to recirculate exhaust gas through the engine. Under normal conditions the exhaust gas must be cooled before recirculation and it is known to pass the exhaust gas through an exhaust gas cooler. The exhaust gas cooler transfers heat between exhaust gas passages and liquid cooled passages in order to cool the exhaust gas before it is re-circulated into engine intake. Under “cold start” or other low operating conditions, the gas can be over-cooled resulting in increased hydrocarbon emission and CO₂ production.

A bypass around the exhaust gas cooler may be provided to allow the exhaust gas to bypass the cooler during such conditions when cooling is not required.

FIG. 1 shows a cut-away view of a known stamped plate exhaust gas heat exchanger/recirculation cooler 10. The exhaust gas cooler 10 has a coolant inlet 4, an exhaust gas inlet 5 and a housing 11 comprising a series of upper and lower plate pairs 2 & 3, and heat transfer fins 6. The exhaust gas cooler 10 also has a coolant outlet and exhaust gas outlet, but these are not shown in FIG. 2.

Each upper 2 and lower plate 3 define a coolant passage therebetween. Between most respective plate pairs (that is between a lower plate 3 of one pair and an upper plate 2 of a further pair) are exhaust gas passages 9. The heat transfer fins 6 are provided in the exhaust gas passages and aid heat exchange between the coolant and the exhaust gas in use.

The plates 2, 3 each have apertures 7 to allow for fluid communication with the exhaust gas inlet 5. The apertures are of equal size, are concentric with each other and collectively define a manifold hole 8.

FIGS. 2a and 2b illustrate the flow direction of two different arrangements of known exhaust gas coolers. FIG. 2a shows an exhaust gas cooler 10a comprising an exhaust gas inlet 12a, an exhaust gas outlet 14a, a coolant inlet 16a, coolant outlet 17a and a core 18a. In the core 18a are a series of coolant passages (not shown) through which the coolant can proceed and a series of cooling passages (not shown) through which the exhaust gas proceeds. Coolant flow is shown generally by arrows 13a and exhaust gas flow is shown generally by arrows 15a. It has now been found by the inventors of the present invention that as the gas flow from inlet 12a approaches the outer side 19a of the exhaust gas cooler 10a, the dynamic pressure is converted to static pressure which can bias the exhaust gas flow through those cooling passages closer to an outer side 19a of the exhaust gas cooler 10a. This problem becomes more acute as an increasing number of stamped plate pairs are utilized in an exhaust gas cooler. This maldistribution of flow results in a substantial reduction in heat transfer. It can also create local areas of high surface temperature which can cause boiling of the liquid coolant.

These problems are also exacerbated where a Z-flow arrangement is utilized, as shown in FIG. 2b, due to the shorter flow path from the area of high static pressure to the exit. The exhaust gas cooler 10b similarly comprises an exhaust gas inlet 12b, exhaust gas outlet 14b, a coolant inlet 16b and coolant outlet 17b and a plurality of cooling and coolant passages for the exhaust gas and coolant respectively in the core 18b. Coolant flow is shown generally by arrows 13b and exhaust gas flow is shown generally by arrows 15b. The provision of the exhaust gas outlet 14b on the outer side 19b encourages gas flow along this side, thus exacerbating the problem.

Certain other exhaust gas coolers have tapered external manifolds which direct the exhaust gas flow more evenly to the exhaust gas cooling passages. However this involves additional external components which increases the space required in the frequently cramped engine layout and does not in any case cater for stamped plate exhaust gas coolers.

Certain known exhaust gas coolers have similarly provided a bypass valve wholly external to the exhaust gas cooler thus increasing the space required by the exhaust gas cooler and bypass.

### SUMMARY OF THE INVENTION

Thus an object of the present invention is to increase the heat-exchange efficiency of an exhaust gas cooler.

A further object of certain embodiments of the present invention is to selectively direct exhaust gas between an exhaust gas cooler and an exhaust gas cooler bypass.

According to a first aspect of the present invention there is provided an exhaust gas cooler comprising:
an exhaust gas inlet;
an exhaust gas outlet;
at least one coolant channel arranged between the exhaust gas inlet and exhaust gas outlet;
a coolant inlet and a coolant outlet in fluid communication with the coolant channel;
a first exhaust gas cooling passage adjacent to the coolant channel;
a second exhaust gas cooling passage adjacent to the coolant channel;
the first and second exhaust gas cooling passages adapted to allow a substantially similar amount of heat to be lost from exhaust gas flowing therethrough;
each exhaust gas cooling passage having an aperture to allow for fluid communication between the exhaust gas inlet and each exhaust gas passage; said apertures, at least in part, defining an inlet chamber;
wherein the inlet chamber is shaped to restrict exhaust gas flow into one of the first and second exhaust gas cooling passages relative to the other of the first and second exhaust gas cooling passages.

The first and second exhaust gas cooling passages are typically adapted to exchange heat with coolant, which in use flows through the coolant channel; that is, they are adapted to allow a substantially similar amount of heat to be lost from exhaust gas flowing therethrough. Thus typically neither the first nor the second exhaust gas cooling passage is a bypass around a main cooling portion of the exhaust gas cooler.

Typically the exhaust gas inlet, in use, directs exhaust gas preferentially towards one of the first and second exhaust gas cooling passages. Preferably the inlet chamber is shaped to restrict exhaust gas flow to said preferential one of the first and second exhaust gas cooling passages. Preferably therefore the difference in the flow rates through the first and second exhaust gas cooling passages is less due to the restriction on exhaust gas flow into one of the first and second exhaust gas cooling passages relative to the other of the first and second exhaust gas cooling passages.

Typically there are more than two exhaust gas cooling passages. Preferably the inlet chamber restricts the flow of exhaust gas to the exhaust gas cooling passages by different amounts.

Typically the exhaust gas inlet, in use, directs exhaust gas preferentially towards the exhaust gas cooling passage which is spaced furthest away from the exhaust gas inlet. Preferably the inlet chamber is shaped to restrict said flow of exhaust gas to said preferential exhaust gas cooling passage, typically in order to reduce the differing flow rate between said exhaust gas cooling passages.

Typically the inlet chamber is shaped to restrict the flow of exhaust gas entering the exhaust gas passages progressively from the exhaust gas cooling passage furthest away from the exhaust gas inlet, which is restricted the most, to the exhaust gas cooling passage which is closest to the exhaust gas inlet, which is restricted the least.

The inlet chamber may be defined only by the apertures or may be defined by the apertures and a flow deflector.

Said apertures of the first and second exhaust gas cooling passages may be of a different size in order to restrict exhaust gas flow into one of the first and second exhaust gas passages relative to the other. Where more than two exhaust gas cooling passages are provided, which is typical, further sizes of aperture may be provided. A progression in the size of the apertures may be provided. Although each exhaust gas cooling passage from the exhaust gas inlet may have a progressively smaller aperture, there may be a first set of passages with the same size of aperture, then a second set of passages, the second set having exhaust gas cooling passages with the same size of aperture as each other but a progressively smaller aperture than the exhaust gas cooling passage of the first set. A third set of exhaust gas cooling passages may be provided having the same size of aperture as each other but a progressively smaller aperture than those of the second set and so on.

Optionally the inlet chamber comprises a flow deflector to restrict exhaust gas flow into one of the first and second exhaust gas cooling passages relative to the other of the first and second exhaust gas cooling passages.

Preferably the inlet chamber comprises a flow deflector having a baffle portion disposed at an angle between the in-use direction of exhaust gas flow from the exhaust gas inlet and the in-use direction of exhaust gas flow through the exhaust gas cooling passages.

Preferably the flow deflector restricts flow to exhaust gas passages spaced away from the exhaust gas inlet. The flow deflector preferably progressively restricts the flow of exhaust gas to the exhaust gas cooling passages as they are spaced away from the exhaust gas inlet. Said progressive restriction may be linear or may not be linear. Progressively restricting exhaust gas flow includes an embodiment where exhaust gas flow is restricted to exhaust gas passages within a set of exhaust gas passages, the sets relative to each other, being progressively restricted in exhaust gas flow, although the exhaust gas passages within the set having little or no variation in the exhaust gas flow restricted thereto.

Optionally the flow deflector comprises an insert having a concave portion which extends towards the exhaust gas passages as it extends away from the exhaust gas inlet. Preferably the insert also comprises a convex portion. Typically the convex portion also extends towards the exhaust gas cooling passages as it extends away from the exhaust gas inlet. Typically therefore such a flow deflector progressively diverts flow into the exhaust gas passages closer to the exhaust gas inlet, thus progressively restricting exhaust gas flow to the exhaust gas passages spaced away from the exhaust gas inlet.

Alternatively the flow deflector can comprise an insert in the shape of a part-cylinder with one end, typically an inlet end, larger than the opposite end, typically an outlet end and the baffle extending directly from said one end to the opposite end.

Alternatively such a flow deflector may comprise a plurality of vanes provided at such an angle. Preferably at least one, more preferably each succeeding vane has a greater area than its preceding vane.

Optionally the flow deflector may comprise an aperture and can be rotatably mounted in the exhaust gas cooler. Preferably therefore the flow deflector can also function as a bypass valve to direct exhaust gas through a bypass passage to avoid substantial cooling in the exhaust gas cooler.

The present invention also provides a flow deflector for an exhaust gas cooler having a first and second exhaust gas cooling passage, said first and second cooling passages adapted to allow a substantially similar amount of heat to be lost from exhaust gas flowing therethrough;
wherein the flow deflector is shaped to restrict exhaust gas flow into one of the first and second exhaust gas cooling passages relative to the other of the first and second exhaust gas cooling passages.

Preferably the exhaust gas cooling passages have an aperture to allow for fluid communication between the exhaust gas inlet and each exhaust gas cooling passage;
said apertures defining a manifold hole and said flow deflector is shaped for insertion into said manifold hole.

Optionally the flow deflector comprises an insert having a concave portion which can, in use, extend towards the exhaust gas passages as it extends away from the exhaust gas inlet. Preferably the insert also comprises a convex portion. Typically the convex portion, can, in use also extend towards the exhaust gas cooling passages as it extends away from the exhaust gas inlet. Typically therefore such a flow deflector progressively diverts flow into the exhaust gas passages closer to the exhaust gas inlet, thus progressively restricting exhaust gas flow to the exhaust gas passages spaced away from the exhaust gas inlet.

Alternatively the flow deflector can comprise an insert in the shape of a part-cylinder with one end, typically an inlet end, larger than the opposite end, typically an outlet end and the baffle extending from said one end to the opposite end.

Alternatively such a flow deflector may comprise a plurality of vanes provided at such an angle. Preferably each succeeding vane has a greater area than its preceding vane.

Optionally the flow deflector may comprise an aperture and can be rotatably mounted in the exhaust gas cooler. Preferably therefore the flow deflector can also function as a bypass valve to direct exhaust gas through a bypass passage to avoid substantial cooling in the exhaust gas cooler.

Each type of deflector may or may not be mounted in a manifold hole.

The present invention also provides an exhaust gas cooler comprising:
an exhaust gas inlet;
an exhaust gas outlet;
at least one coolant channel arranged between the exhaust gas inlet and exhaust gas outlet;
a coolant inlet and a coolant outlet in fluid communication with the coolant channel;
a first exhaust gas cooling passage adjacent to the coolant channel;
a second exhaust gas cooling passage adjacent to the coolant channel;
the first and second exhaust gas cooling passages adapted to allow a substantially similar amount of heat to be lost from exhaust gas flowing therethrough; and
   a flow deflector as described herein.

The flow deflector may be any of the flow deflectors described herein, optionally including any of the optional features described herein.

The exhaust gas cooler may comprise a bypass adapted to allow a differing amount of heat to be lost from exhaust gas flowing therethrough relative to the first and second exhaust gas cooling passages and the flow deflector may be rotatably mounted in the exhaust gas cooler.

Such embodiments thus allow for a flow deflector to be utilized as a bypass valve in addition to restricting flow to one of the exhaust gas cooling passages.

Optionally each exhaust gas cooling passage has an aperture to allow for fluid communication between the exhaust gas inlet and each exhaust gas passage; said apertures, at least in part, defining a manifold hole; the flow deflector may or may not be provided within said manifold hole.

Typically the flow deflector also comprises an aperture which can, in one rotational orientation, allow for exhaust gas flow to proceed through the bypass passages and, in a second rotational orientation, prevent exhaust gas from flowing through the bypass passage. Intermediate rotational positions to allow a portion of the exhaust gas to flow through the bypass passage may also be provided for.

### BRIEF DESCRIPTION OF THE DRAWINGS

Embodiments of the present invention will now be described, by way of example only, with reference to the accompanying drawings in which:

FIG. 1 is a cut-away view of one end of a known stamped-plate exhaust gas cooler;

FIG. 2a is a diagrammatic view showing the exhaust gas flow path in a known U-flow type exhaust gas cooler;

FIG. 2b is a diagrammatic view showing the exhaust gas flow path in a known Z-flow type exhaust gas cooler;

FIG. 3 is a cut-away view of one end of a stamped-plate exhaust gas cooler in accordance with one embodiment of the present invention;

FIG. 4 is a perspective view of a flow deflector in accordance with one embodiment of the present invention;

FIG. 5 is a perspective view of a further flow deflector in accordance with a second embodiment of the present invention;

FIG. 6 is a perspective view of a yet further flow deflector in accordance with a third embodiment of the present invention;

FIG. 7 is a side sectional view of an exhaust gas cooler in accordance with a further aspect of the present invention;

FIG. 8a is a perspective view of the FIG. 4 flow deflector rotatably mounted in a bypass assembly in accordance with a further aspect of the present invention;

FIG. 8b is a further view of the FIG. 8a flow deflector and bypass assembly, the flow deflector being in a different rotational orientation than that shown in FIG. 8a;

FIG. 8c is a further view of the flow deflector and bypass assembly of FIG. 8a, the flow deflector being in a further rotational orientation than those shown in FIGS. 8a and 8b;

FIG. 9a is a further view of the flow deflector and bypass assembly of FIG. 8a along with a portion of an exhaust gas cooler;

FIG. 9b is a further view of the FIG. 9a flow deflector, bypass assembly and exhaust gas cooler with the flow deflector being in a different rotational orientation than that shown in FIG. 9a; and,

FIG. 9c is a further view of the FIG. 9a flow deflector, bypass assembly and exhaust gas cooler with the flow deflector being in a third rotational orientation.

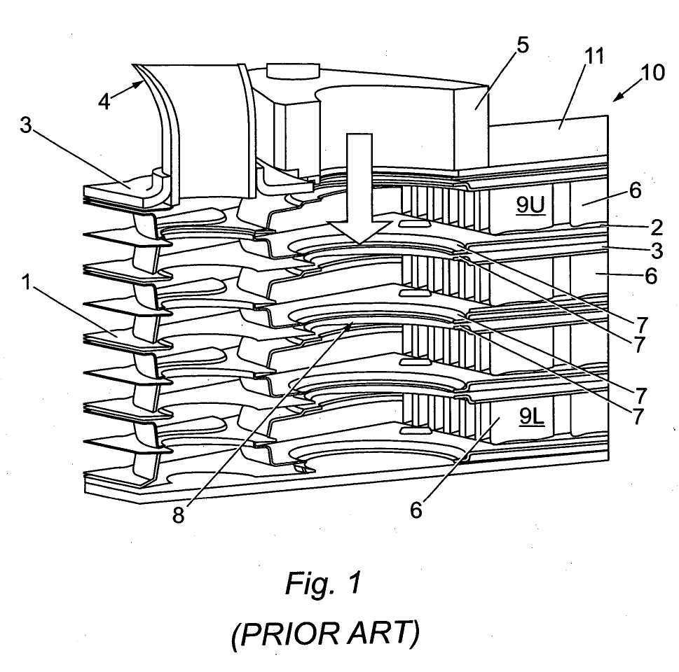

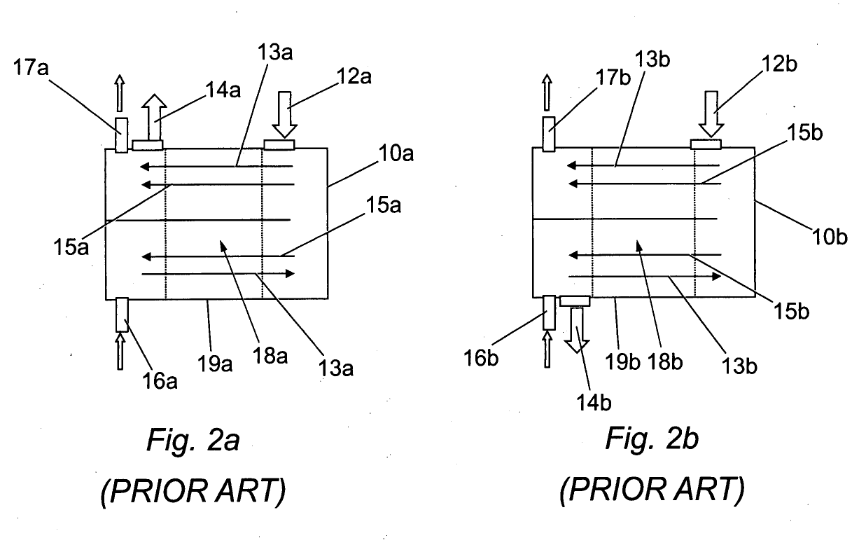

### DETAILED DESCRIPTION OF PREFERRED EMBODIMENTS

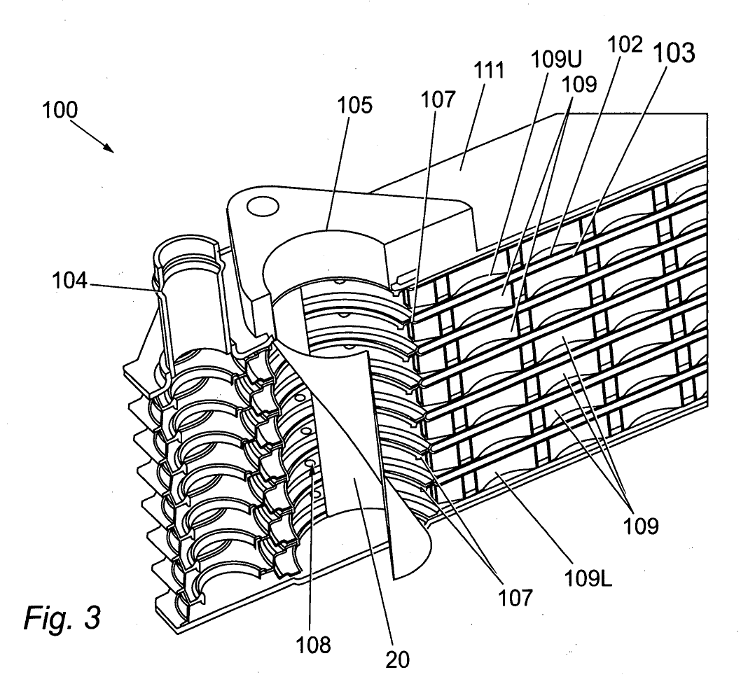

FIG. 3 shows a cut-away view of a stamped plate exhaust gas heat exchanger/recirculation cooler 100 according to one embodiment of the present invention. The exhaust gas cooler 100 has a coolant inlet 104, an exhaust gas inlet 105 and a housing 111 comprising a series of upper and lower plate pairs 102 & 103. The exhaust gas cooler 10 also has a coolant outlet, exhaust gas outlet and heat transfer fins but these are not shown in FIG. 3.

Each upper 102 and lower plate 103 define a coolant passage therebetween. Between most respective plate pairs (that is between a lower plate 103 of one pair and an upper plate 102 of a further pair) are exhaust gas passages 109. The heat transfer fins are provided in the exhaust gas passages and aid heat exchange between the coolant and the exhaust gas in use.

The plates 102, 103 each have apertures 107 to allow for fluid communication with the exhaust gas inlet 105. The apertures are of equal size, are concentric with each other and collectively define a manifold hole 108.

Certain embodiments of the present invention are exhaust gas coolers including a deflector which, along with the manifold hole 108, form an inlet chamber shaped such that exhaust gas flow is progressively restricted into the coolant passages as they are spaced away from the exhaust gas inlet 105.

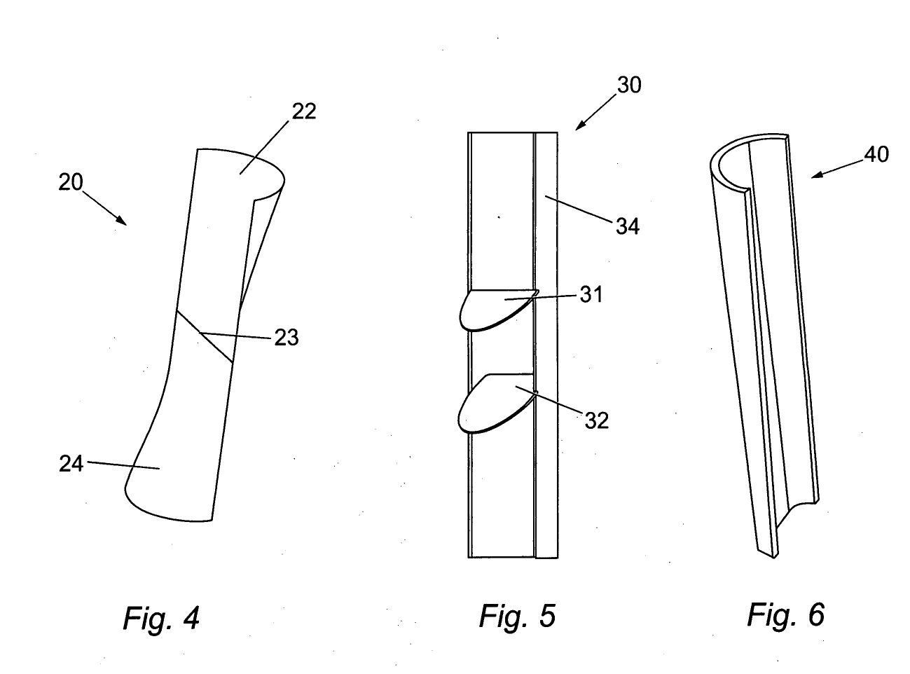

The exhaust gas cooler 100 comprises a preferred embodiment of a deflector 20 in the manifold hole 108. The deflector 20 is shown in more detail in FIG. 4 where is can be seen to comprise a concave portion 22 and a convex portion 24. Looking down the main axis of the deflector 20, the concave portion 22 has a ‘)-shaped’ profile. The curve of the concave portion 22 gradually reduces in size towards a mid-point 23 in the deflector 20. At the mid-point 23 the deflector 20 is substantially flat, and its profile is substantially ‘|-shaped’. The gradual change in size of the curvature of the concave portion 22 continues past the mid-point 23 to form the convex portion 24. The curve of the convex portion 24 gradually increases as it extends from the mid-point 23 to its end, where it has an ‘(-shaped’ profile.

This concave-convex shape, although relatively complex, may be easily stamped or otherwise formed. As shown in FIG. 3, this deflector 20 is provided in the manifold hole 108 and is attached to the exhaust gas cooler 100 at the top and optionally at the bottom by, for example, welding, brazing or bolting. At the exhaust gas inlet 105, the concave shape follows the geometry of the manifold hole 108 opposite the exhaust gas passage side, therefore providing essentially no or little restriction to exhaust gas at the upper end of the exhaust gas cooler 100. As the deflector 20 extends further into the manifold hole 108, the flow area gradually decreases thus restricting flow to the lower passages; the shape changes from concave to convex and the flow area continues to decrease, further restricting exhaust gas flow to the even lower passages 109. This continues until the deflector 20 reaches the bottom of the exhaust gas cooler 100 where the deflector follows the geometry of the manifold hole 108 at the exhaust gas passage side 109. Thus the deflector within the manifold hole 108 is at an angle between that of the direction of exhaust gas flow from the exhaust gas inlet 105 and the direction of exhaust gas flow of the exhaust gas through the exhaust gas passages 109.

In use, little or no restriction is provided for exhaust gas to flow into the uppermost exhaust gas passage 109U. The second exhaust gas passage 109 has a small restriction due to the reduced diameter of the inlet chamber caused by the narrowing, concave shape of the deflector 20. This restriction continues progressively until the lowermost exhaust gas passage 109L where the exhaust gas flow is restricted the most since the convex shape of the deflector 20 allows only a small area for exhaust gas to pass through the inlet chamber and into the lowermost exhaust gas passage 109L.

Thus the increased tendency for exhaust gas to flow through the exhaust gas passages further away from the exhaust gas inlet 105 is offset, at least in part, by the restriction provided by the deflector 20. The deflector 20 thus provides a more balanced flow through each exhaust gas passage 109 which in turn improves the overall efficiency of the exhaust gas cooler 100.

Exhaust gas flow in previous exhaust gas coolers can result in the bottom of the manifold hole 108 receiving additional static pressure in one area, particularly directly opposite the exhaust gas inlet 105. This causes hotspots and increased pressure loss which reduce the efficiency of the exhaust gas cooler further. Embodiments of the present invention, such as the deflector 20, reduce or prevent such hot-spots developing, thus increasing the efficiency of the exhaust gas cooler further. Also, embodiments of the present invention, such as the deflector 20, reduce the pressure drop of exhaust gas which proceeds through an exhaust gas cooler. Minimal pressure drop of the exhaust gas through an exhaust gas cooler is beneficial.

A further embodiment of a deflector 30 is shown in FIG. 5. This embodiment utilizes a plurality of vanes, such as the vanes 31 & 32, provided on a C-shaped cartridge 34. In place of the deflector 20, the deflector 30 is provided in the manifold hole 108 of the exhaust gas cooler 110 and the vanes 31, 32 serve to divert exhaust gas into the exhaust gas passages 109. The inlet chamber is defined by the manifold hole 108 and the deflector 30. The vanes 31, 32 are provided along the length of the cartridge 34 at an angle between that of the direction of exhaust gas flow from the exhaust gas inlet 105 and the direction of exhaust gas flow of the exhaust gas through the exhaust gas passages 109. Each succeeding vane, for example vane 32, is larger than the preceding vane, for example vane 31, such that at each intercept point (the leading edge of the vane), a more or less equal portion of the exhaust gas is deflected into the exhaust gas passages 109. Typically there will be more than two such vanes, the exact number depending on the number of exhaust gas passages. Certain embodiments of the present invention have the same number of vanes as there are exhaust gas passages. Other embodiments have less vanes to exhaust gas passages, for example, one vane per three to six exhaust gas passages.

Thus in use, exhaust gas will proceed into the manifold hole 108 with the deflector 30 therein. Some exhaust gas will be deflected by the vane 31 into the adjacent exhaust gas passage(s) 109. Exhaust gas which is not deflected by vane 31 can continue toward the bottom of the manifold hole 108 where it may be deflected by vane 32, particularly since vane 32 is larger than vane 31, into the adjacent exhaust gas passage(s) 109. Remaining exhaust gas can continue down the manifold hole 108 and is gradually and progressively deflected towards the adjacent exhaust gas cooling passages 109.

This embodiment also serves to reduce the imbalance between the amount of flow through the various exhaust gas passages by restriction of the flow through the lower passages by diverting the exhaust gas into the upper exhaust gas passages. The pressure loss and tendency for hot spots to occur are also reduced utilizing such embodiments.

A further embodiment 40 is shown in FIG. 6. The deflector 40 comprises a half-cylinder 42 cut at an angle to form a part-cylinder 42 with an upper end having a larger edge than its lower end. This results in a concave portion with, looking down its main axis, a C-shaped profile. The profile of the part-cylinder gradually reduces towards its opposite end due to the angled cut. In place of the deflector 20, the deflector 40 is provided in the manifold hole 108 of the exhaust gas cooler 100 at an angle between that of the direction of exhaust gas flow from the exhaust gas inlet 105 and the direction of exhaust gas flow of the exhaust gas through the exhaust gas passages 109. This progressively reduces the flow area towards the lower end of the manifold hole 108 thus restricting exhaust gas flow to the lower exhaust gas passages 109. This restriction, in use, also serves to redress the imbalance in exhaust gas flow between the various exhaust gas passages by restricting exhaust gas flow to the lower exhaust gas passages 109. The pressure loss and tendency for hot spots to occur are also reduced utilizing such embodiments.

While the deflector 40 will might not always show as great an improvement in performance as the deflector 20, but it has the advantage of being simpler and cheaper to tool. Furthermore, certain exhaust gas coolers have a “D-shaped” manifold hole which are particularly suited to the deflector 40. In such embodiments, the benefits of this shape may approach that of the preferred embodiment.

It is preferred but not essential to form the deflector 40 by cutting a cylinder or half-cylinder. Alternatively a mould may be provided to form the same shape.

The lower end of the deflector 40 may in fact be flattened rather than curved and so such embodiments are not formed from a cylinder. These embodiments are particularly suitable for exhaust gas coolers with a D-shaped manifold hole.

A further benefit of certain embodiments of the present invention, for example, the deflectors 20, 30, 40 is that when they are attached firmly to the top and bottom of the manifold hole 108, they add structural rigidity to the exhaust gas cooler, improving its resistance to pressure fatigue, and potentially to vibration.

A further benefit of certain embodiments of the present invention is that they may be employed in heat exchangers of any material.

In each of the embodiments 20, 30, 40 the deflectors may be provided separately and retro-fitted to existing exhaust gas coolers. Preferably however they are provided as components of an exhaust gas cooler.

Modified deflectors 20, 30, 40 may be used which do not start at the top of the manifold hole, but start part of the way down the manifold hole.

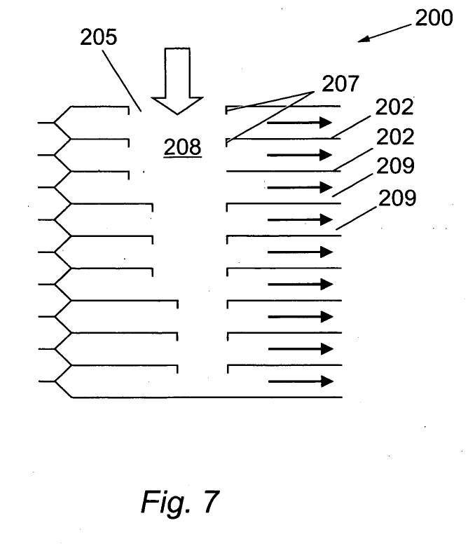

FIG. 7 shows a simplified view of a further embodiment 50 of the present invention. An exhaust gas cooler 200 is shown comprising an exhaust gas inlet 205 and exhaust gas passages 209 and an inlet chamber 208 defined by apertures 207 in plate pairs 202. Coolant passages and a coolant inlet are provided but are omitted from FIG. 7 for clarity.

The apertures 207 of the plate pairs decrease in size in order to restrict flow of exhaust gas to the lower passages. Preferably two or three plate pairs are provided with an equal size of apertures in order to simplify assembly.

Thus in use, exhaust gas proceeds through the exhaust gas inlet 205. The flow area of the inlet chamber 208 gradually reduces in size which restricts flow to the lower exhaust gas passages 209 and encourages the exhaust gas to proceed through the upper exhaust gas passages 209.

This embodiment also serves to reduce the imbalance between the amount of flow through the various exhaust gas passages by restriction of the flow through the lower passages. The pressure loss and tendency for hot spots to occur are also reduced utilizing such embodiments.

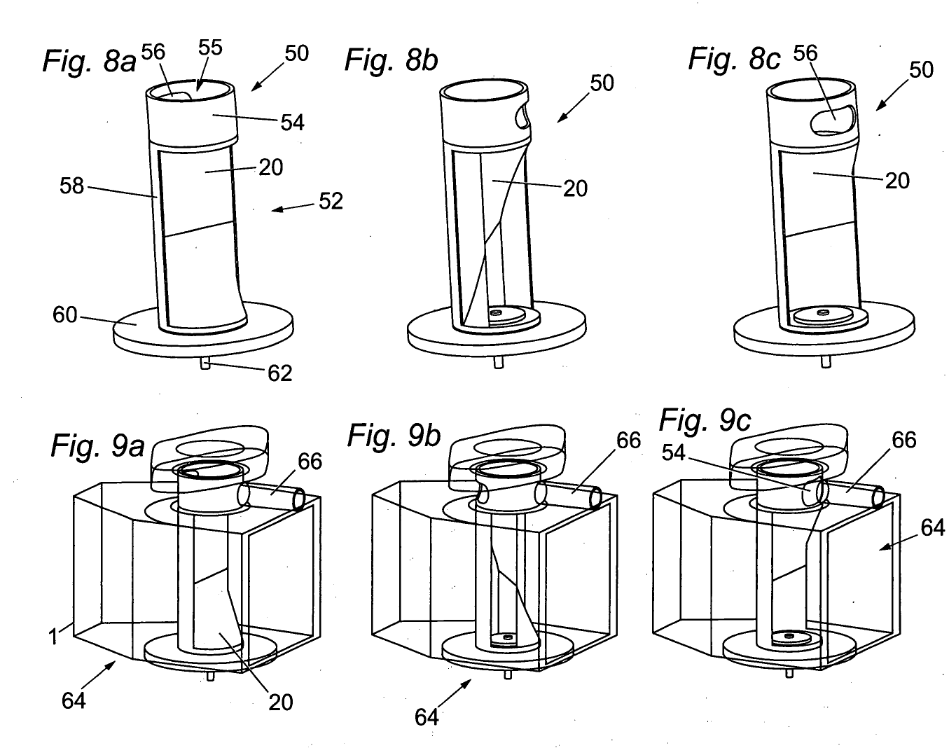

A further embodiment of the present invention is shown in FIGS. 8a-8c and 9a-9c. This embodiment 50 includes the deflector 20 of the first preferred embodiment, rotatably mounted within a frame 52. The frame 52 comprises an upper collar 54 with an aperture 56, a half cylinder body 58, a base plate 60 and a locating boss 62.

The frame 52 is provided within a manifold hole of an exhaust gas cooler 64, as shown in FIG. 9a, typically by securing the boss 62 in an appropriate socket (not shown) on the bottom of the manifold hole. The exhaust gas cooler 64 comprises a bypass passage 66 but is otherwise the same as the exhaust gas cooler 100 and like components will not be described further. The bypass passage 66 typically serves to reduce cooling of the exhaust gas proceeding therethrough and may be utilized on, for example, engine start-up where the exhaust gas may otherwise be over-cooled. The collar 54 is aligned with the bypass passage 66 of the exhaust gas cooler 64.

In use, the deflector 20 is provided in a normal position shown in FIGS. 8a, 9a as described above with respect to the deflector 20, that is, at an exhaust gas inlet 55, the concave shape provides little or no restriction to the adjacent exhaust gas passages, whilst towards the lower exhaust gas passages away from the exhaust gas inlet 55, the exhaust gas flow is progressively restricted. When less cooling of the exhaust gas is required, the flow deflector 20 and the collar 54 are rotated, through the position shown in FIGS. 8b and 9b, to the position shown in FIGS. 8c, 9c. In this position the aperture 56 within the collar 54 is aligned with the bypass passage 66 allowing the exhaust gas to bypass the exhaust gas passages.

Moreover access to the exhaust gas passages is blocked by the half-cylinder 58 and the—now reversed—concave portion of the deflector 20.

Embodiments of the present invention thus provide a bypass valve to direct exhaust gas through a cooling portion and a non-cooling or minimal cooling portion of an exhaust gas cooler.

An advantage of such embodiments is that packaging space required for such a bypass valve is minimized because the valve is provided within the manifold hole.

Pneumatic or electric actuator (not shown) can be used to control the rotation of the deflector 20.

The actuator is controlled by an Engine Control Unit (ECU), which can take work in a number of different ways. It can take simple temperature measurements of the coolant and/or the exhaust gas and modulate the proportion of gases which bypass depending on the temperatures detected. Alternatively or additionally a load versus speed map may be programmed into the ECU to modulate the proportion of uncooled exhaust gas required. The richness of the air/fuel mix may be assessed as can the combustion temperature and the temperature of different engine components. All these factors can be used in a calculation to determine the proportion of exhaust gas which is cooled. A combination of these control mechanisms may also be utilized.

Improvements and modifications may be made without departing from the scope of the invention.

We claim:

1. An exhaust gas cooler comprising:
an exhaust gas inlet;
an exhaust gas outlet;
at least one coolant channel arranged between the exhaust gas inlet and exhaust gas outlet;
a coolant inlet and a coolant outlet in fluid communication with the coolant channel;
a first exhaust gas cooling passage adjacent to the coolant channel;
a second exhaust gas cooling passage adjacent to the coolant channel;
the first and second exhaust gas cooling passages adapted to allow a substantially similar amount of heat to be lost from exhaust gas flowing therethrough;
each exhaust gas cooling passage having an aperture to allow for fluid communication between the exhaust gas inlet and each exhaust gas passage; said apertures, at least in part, defining an inlet chamber;
wherein the inlet chamber is shaped to restrict exhaust gas flow into one of the first and second exhaust gas cooling passages relative to the other of the first and second exhaust gas cooling passages.

2. An exhaust gas cooler as claimed in claim 1, wherein the inlet chamber is shaped to restrict exhaust gas flow to the exhaust gas passage spaced further away from the exhaust gas inlet.

3. An exhaust gas cooler as claimed in claim 1, comprising more than two exhaust gas cooling passages, wherein the inlet chamber is shaped to progressively increase the restriction on the flow of exhaust gas entering the exhaust gas passages, from the exhaust gas cooling passage which is closest to the exhaust gas inlet to the exhaust gas cooling passage furthest away from the exhaust gas inlet.

4. An exhaust gas cooler as claimed in claim 1, wherein said apertures of the first and second exhaust gas cooling passages are of a differing size in order to restrict exhaust gas flow into one of the first and second exhaust gas passages relative to the other.

5. An exhaust gas cooler as claimed in claim 1, wherein the exhaust gas cooler comprises more than two exhaust gas cooling passages and there is a progressive reduction in the size of the apertures in at least some of the successive exhaust gas cooling passages as the exhaust gas cooling passages are spaced away from the exhaust gas inlet.

6. An exhaust gas cooler as claimed in claim 1, wherein the inlet chamber comprises a flow deflector having a baffle portion disposed at an angle between the direction of exhaust gas flow from the exhaust gas inlet and the direction of exhaust gas flow through the exhaust gas cooling passages.

7. An exhaust gas cooler as claimed in claim 6, wherein the flow deflector is shaped to progressively increase the restriction on the flow of exhaust gas to at least some of the exhaust gas cooling passages as they are spaced further away from the exhaust gas inlet.

8. An exhaust gas cooler as claimed in claim 6, wherein the flow deflector has a concave portion which extends towards the exhaust gas cooling passages as it extends away from the exhaust gas inlet.

9. An exhaust gas cooler as claimed in claim 8, wherein the flow deflector also comprises a convex portion which extends towards the exhaust gas cooling passages as it extends away from the exhaust gas inlet.

10. An exhaust gas cooler as claimed in claim 6, wherein the flow deflector comprises a part-cylinder with an inlet end larger than an outlet end, and the baffle portion extending directly from said one end to the opposite end.

11. An exhaust gas cooler as claimed in claim 6, wherein the flow deflector comprises a plurality of vanes.

12. An exhaust gas cooler as claimed in claim 11, wherein a first vane has a greater area than a second vane, the second vane being spaced closer to the exhaust gas inlet than said first vane.

13. An exhaust gas cooler as claimed in claim 1, wherein the exhaust gas coolant passages are formed from stamped plates.

14. An exhaust gas cooler as claimed in claim 6, wherein the flow deflector comprises a bypass aperture and the flow deflector is rotatably mounted in the exhaust gas cooler.

15. A flow deflector for an exhaust gas cooler having a first and second exhaust gas cooling passage, said first and second cooling passages adapted to allow a substantially similar amount of heat to be lost from exhaust gas flowing therethrough;
wherein the flow deflector is shaped to restrict exhaust gas flow into one of the first and second exhaust gas cooling passages relative to the other of the first and second exhaust gas cooling passages.

16. A flow deflector as claimed in claim 15, wherein the exhaust gas cooling passages have an aperture to allow for fluid communication between the exhaust gas inlet and each exhaust gas cooling passage;
said apertures defining a manifold hole and said flow deflector being shaped for insertion into said manifold hole.

17. A flow deflector as claimed in claim 15, wherein the flow deflector is shaped to progressively increase the restriction on the flow of exhaust gas to at least some of the exhaust gas cooling passages as they are spaced further away from the exhaust gas inlet.

18. A flow deflector as claimed in claim 15, wherein the flow deflector has a concave portion which extends towards the exhaust gas cooling passages as it extends away from the exhaust gas inlet.

19. A flow deflector as claimed in claim 18, wherein the flow deflector also comprises a convex portion which extends towards the exhaust gas cooling passages as it extends away from the exhaust gas inlet.

20. A flow deflector as claimed in claim 15, wherein the flow deflector comprises a part-cylinder with an inlet end larger than an outlet end, and the baffle portion extending from said one end to the opposite end.

21. A flow deflector as claimed in claim 15, wherein the flow deflector comprises a plurality of vanes.

22. A flow deflector as claimed in claim 21, wherein a first vane has a greater area than a second vane, the second vane being spaced closer to the exhaust gas inlet than said first vane.

23. A flow deflector as claimed in claim 22, wherein the flow deflector comprises a bypass aperture and the flow deflector is adapted to be rotatably mounted in the exhaust gas cooler.

24. An exhaust gas cooler comprising:
an exhaust gas inlet;
an exhaust gas outlet;
at least one coolant channel arranged between the exhaust gas inlet and exhaust gas outlet;
a coolant inlet and a coolant outlet in fluid communication with the coolant channel;
a first exhaust gas cooling passage adjacent to the coolant channel;
a second exhaust gas cooling passage adjacent to the coolant channel;
the first and second exhaust gas cooling passages adapted to allow a substantially similar amount of heat to be lost from exhaust gas flowing therethrough; and
a flow deflector as claimed in claim 15.

25. An exhaust gas cooler as claimed in claim 24, wherein the flow deflector has a concave portion which extends towards the exhaust gas cooling passages as it extends away from the exhaust gas inlet.

26. An exhaust gas cooler as claimed in claim 25, wherein the flow deflector also comprises a convex portion which extends towards the exhaust gas cooling passages as it extends away from the exhaust gas inlet.

27. An exhaust gas cooler as claimed in claim 24, wherein the flow deflector comprises a part-cylinder with an inlet end larger than an outlet end, and the baffle portion extending from said one end to the opposite end.

28. An exhaust gas cooler as claimed in claim 24, wherein the flow deflector comprises a plurality of vanes.

29. An exhaust gas cooler as claimed in claim 28, wherein a first vane has a greater area than a second vane, the second vane being spaced closer to the exhaust gas inlet than said first vane.

30. An exhaust gas cooler as claimed in claim 24, further comprising a bypass adapted to allow a differing amount of heat to be lost from exhaust gas flowing therethrough relative to the first and second exhaust gas cooling passages;
and wherein the flow deflector is rotatably mounted in the exhaust gas cooler.

31. An exhaust gas cooler as claimed in claim 30, wherein the flow deflector also comprises an aperture which, in one rotational orientation, allows for exhaust gas flow to proceed through the bypass passage and, in a second rotational orientation, prevents exhaust gas from flowing through the bypass passage.
